(19) United States
(12) Patent Application Publication
(10) Pub. No.: US 2008/0308966 A1
(43) Pub. Date: Dec. 18, 2008

(54) Production Process for Twistable Polymer Film or Similar Product, Film Thus Obtained for Packaging and Others, and Application

(76) Inventor: Jeferson Luiz Anzanello, Santa Catarina (BR)

Correspondence Address: DALINA LAW GROUP, P.C., 7910 IVANHOE AVE. #325, LA JOLLA, CA, 92037, US

(21) Appl. No.: 11/815,200

(22) PCT Filed: Jan. 30, 2006
(86) PCT No.: PCT/BR2006/000009

§ 371 Date: Aug. 19, 2008

(30) Foreign Application Priority Data
Jan. 31, 2005 (BR) PI 0500266-4
Dec. 14, 2005 (BR) C1 0500266-4

(51) Int. Cl. B29C 47/04

(52) U.S. Cl. 264/210.6

(57) ABSTRACT

The present invention refers to a production process for twistable polymer film or similar, film thus obtained for packaging and others and applications is a practical and innovative laminate or polymer film with the addition of resin in the extrusion process, which gives the final product a twisting effect, maintaining it in this twisted state, and without returning to the initial position, allowing the packaging of different goods, such as foodstuff, hygiene and cleaning products, or animal nutrients, among others, to be opened or closed by a simple manual twisting, keeping the packaged product preserved with the same original properties. The object of the present invention idealizes a process for the preparation of a polyethylene film with torsion properties, which is obtained through the combination of resins and additives introduced in the film extrusion process, which can be of blow or cast type, also varying in either single-extrusion or co-extrusion, where the extruded film can be pigmented with any color, white, blue, among others, through the addition of colored pigments in the production process, or transparent when no pigment is introduced.

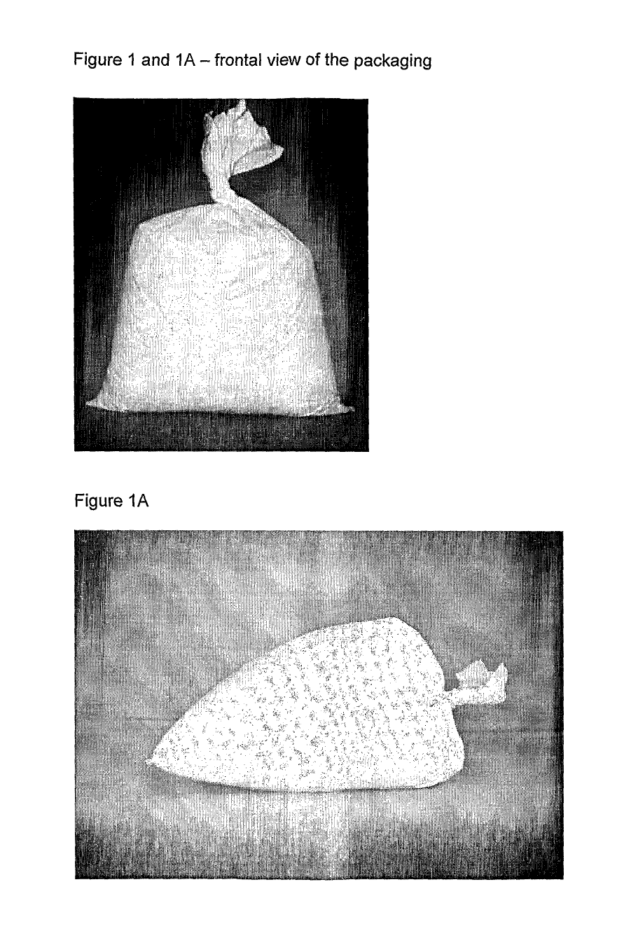

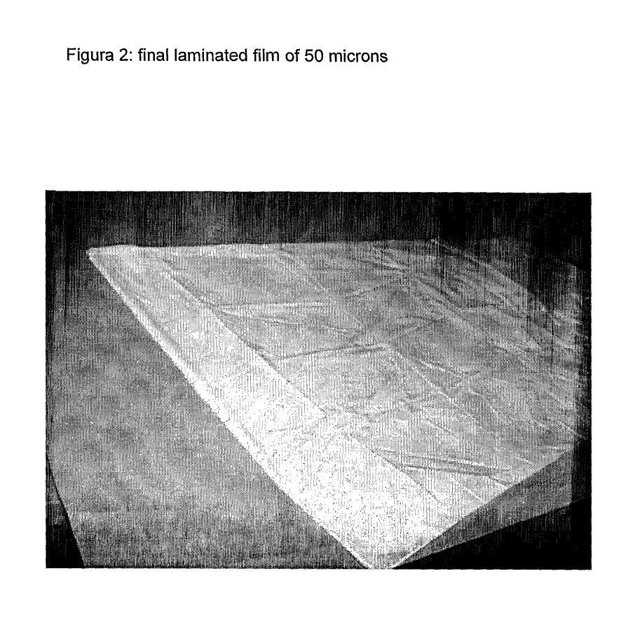

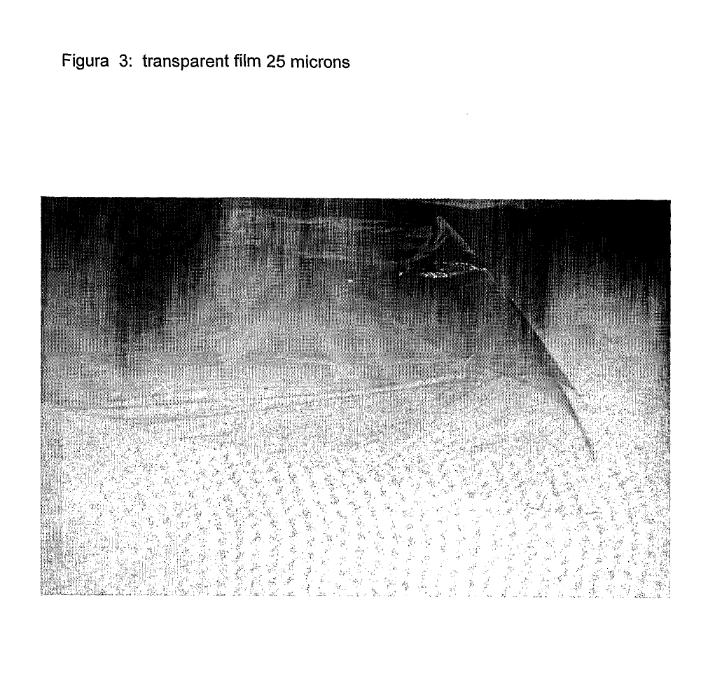

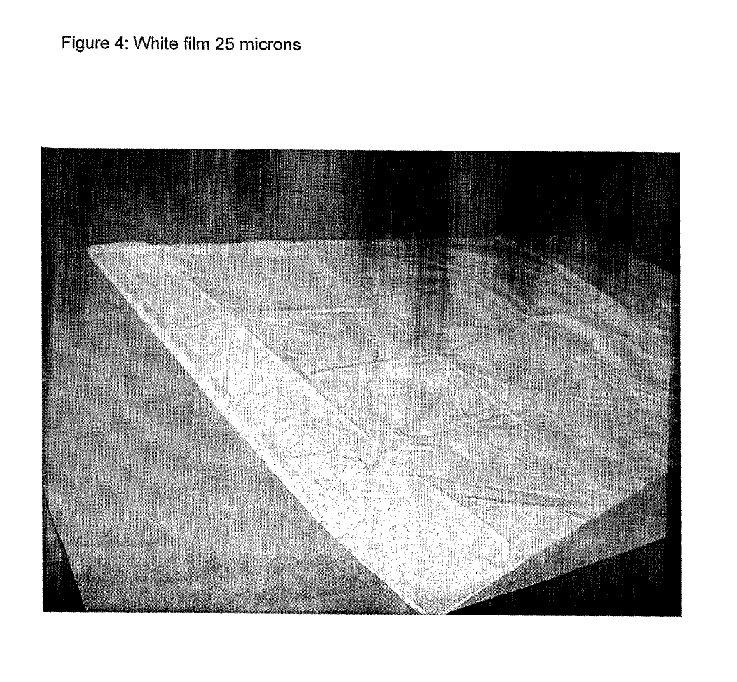

### FIELD OF INVENTION

The purpose of the present invention is a practical and innovative laminate or polymer film with the addition of resin in the extrusion process, which gives the final product a twisting effect, maintaining it in this twisted state, and without returning to the initial position, allowing the packaging of different goods, such as foodstuff, hygiene and cleaning products, or animal nutrients, among others, to be opened or closed by a simple manual twisting, keeping the packaged product preserved with the same original properties, destined for the packaging industry segment, created with an intelligent and original constructive build, for the purposes of producing low-cost productive and highly functional performance packaging, simplifying its protection after the first use, whose seal is processed through a simple twist of its sectioned part, which can be used in humid domestic or commercial environments, where the technique facilitates the development of innovative packaging, with wrapping surfaces, equipped with mechanical twisting attributes, impermeability, differentiated tactile and visual aspects.

The required patent therefore describes a laminate with torsion attributes for application in packaging of various products, specifically designed and developed to provide the user, quality product storage when in use, preserving its content from exposure to natural or induced humidity, with simplicity, and without compromising the quality of the aesthetic presentation.

Furthermore, the purpose of this patent is to present a protective wrapper for hygiene and cleaning products, constructed with a twistable polymer film, industrial feasibility from its low costs, aggregating aesthetic requirements, safety with physical torsion properties, reaffirming its service practicality, giving the consumer of this accessory, additional liberty and options in the same market segment, offering innumerous possibilities and benefits, making it a specific product of great expectation for this consumer market.

### BACKGROUND OF THE INVENTION

Traditionally, hygiene and cleaning products like soaps, powdered detergents for washing clothes, foodstuff, animal nutrients, among other articles, are wrapped in simple paper pack, bagged where users naturally use several artifices in order to close the pack, after the first use of the product inside in order to preserve original and natural properties, such as flavor, aroma, among other attributes, of product leftovers in the pack.

In recent years, industries of the sector have offered packaging manufacturers and consumers, devices that provide the possibility of sealing packs once they have been opened, such as plastic zippers, self-adhesive labels, plastic clips, metallic staples, etc, wherein these devices, usually, besides aggregating costs, cannot be employed or used in some types of packaging like those produced in vertical automatic VFFS type (Vertical Form Fill and Seal) packaging systems, with simple polyethylene, polypropylene or polyethylene laminate with polyethylene films.

In VFFS type systems with polyester laminated films, with polyethylene, or polyethylene-oriented polypropylene, there is a zipper application system, although it continues to be an expensive device aggregated to the film.

Observe that there is also the existence of polypropylene films with torsion properties, also known as PPT, largely used in candy and bonbon packs. However, this type of film may not be suitable for use in VFFS type packaging systems, and for wrapping products that require drop resistance, since one of the PP torsion properties (PPT) is to have a high coefficient of friction (COF), and low resistance to dropping due to the inherent molecular structure of the PPT. If this same type of film is produced in cast extrusion process, these properties tend to worsen, adding to it the tendency to tear towards the direction of the Machine (DM), typical of cast extrusion of more rigid materials through the longitudinal direction of the machine.

Upon subjecting this type of material to a shelf drop simulation, the packaging will break whether it is in the body of the packaging or in the region next to the sealing. Added to this is the fact that the sealing characteristics of this resin present themselves inferior to the properties of the film, purpose of this patent. This is due to the fact that polypropylene requires higher sealing temperature by presenting a higher softening point and lesser sealing resistance than polyethylene. Any attempt of adding resins to the PPT composition, to improve the drop-rupture properties, will reduce torsion properties. Another attempt to adapt the COF of the material, by lowering it to process in VFFS type equipments, will also drastically reduce the properties of the PPT material in maintaining it twisted, due to slipping and/or sliding between the surfaces of the twisted film.

Starting with the verification of the limitations imposed in the technique, the present invention proposes, through a specific technical development, a polyethylene film with torsion attributes that will satisfy the requirements and needs demanded by the market related to the issue once it provides, through simple manual twisting, the possibility of opening or closing the packaging that will condition the products defined herein, maintaining them conserved and preserving their original properties.

The twistable polymer film can be used in other industrial systems besides the VFFS (Vertical Form Fill and Seal) type system for packaging various types of products such as, human and animal foodstuff, chemicals, hygiene and cleaning products, whether personal or intimate, or for environments, packaging civil construction components, or for use in civil construction, pharmaceutical products, office/stationery implements manufacturing inputs, office/stationery packs, clothing products and clothing packs, and automobile industry products. It is composed of at least 15% cyclic copolymer (CCO).

The present invention is related to the packaging industry sector and has the purpose of introducing into the market an innovative and original constructive structure with the intention of producing low-cost production packaging, and highly functional performance, simplifying its protection after the first use, in respect to the sealing modality, processed by simple twisting of its sectioned portion, which can be used in humid domestic or commercial environments. The twistable polymer film can be used in other industrial systems, besides the VFFS (Vertical Form Fill and Seal) type systems for packaging several types of products like, foodstuff, hygiene and cleaning products, or animal foodstuff, among others.

The present invention provides a laminate with torsion attributes for application in the packaging of several products, specifically designed and developed to provide the user, product storage quality when in use, preserving its content from exposure to natural or induced humidity, with simplicity, and without compromising the aesthetic quality of presentation.

Furthermore, the scope of the present invention is a protective wrapper for hygiene and cleaning products, constructed with a twistable polymer film, at low costs for its industrial feasibility, which aggregates aesthetic requirements, safety with physical torsion properties, reaffirms its service practicality, giving the consumer of this accessory additional liberty and option in the same market segment, offering innumerous possibilities and benefits, which makes it a specific product of great expectation for this consumer market which demands the development of innovative packaging with wrapping surfaces, equipped with mechanical torsion features, impermeability, differentiated tactile and visual aspects.

The inventor, based on his association to the industry, took into consideration the possible inconveniences, differentials and improvements, having designed and developed the object of the present invention, i.e. a production process for twistable polymer film or similar product, and the film thus obtained for packaging, and other applications claimed herein, presenting the descriptions of the process involved.

### THE INVENTION

The object of the present invention idealizes a process for the preparation of a polyethylene film with torsion properties, which is obtained through the combination of resins and additives introduced in the film extrusion process, which can be of blow or cast type, also varying in either single-extrusion or co-extrusion, where the extruded film can be pigmented with any color, white, blue, among others, through the addition of colored pigments in the production process, or transparent when no pigment is introduced.

The transparent or colored extruded film can present varying or specific writing styles and colorations relative to the intended motifs or ornamentations with the objective of interacting, informing and even instructing the user through the printing process, or sharing with the use of adhesives in a two-film laminating machine, obtaining a film denominated as laminate.

Once the user has opened the packaging produced with twistable polymer film, they can close it again, by simply and manually twisting it sectioned part axially, which does not return afterwards to its initial position, before plastic deformation.

The twistable polymer film for packaging provides protection from harsh weather, aesthetic, ornamental, marking or interactive presentation, with flexible thread-like lamellar structure produced from an extruded and synthetic base, acquiring torsion property once resins and additives have been added to the extrusion process.

Temperatures and other adjustments of the process and machine parameters are adjusted in accordance with the balance of the film components and thickness.

The thickness of the film can vary from fifteen (15) to a hundred (100) microns, in accordance with the application.

The twistable polymer laminate can be sectioned, through different industrial processes, as well as sewn, pasted or applied on packaging for different purposes.

Thus, the present invention was designed aiming at obtaining a product for the packaging of hygiene and cleaning articles, among other applications, with fewer number of possible production processes, conveniently developed and created to allow the user to have his products protected against humidity with performance, efficiency and quality that demonstrates unequaled practicality and versatility, incorporating peculiar performances, like the torsion capacity relative to the state of the art.

Its innovative concept allows one to obtain a constructive structure with an excellent level of functionality, which is developed according to the most modern techniques, thus, facilitating simplified use in relation to personal, commercial and industrial use.

It is understood that the product developed for the protection, finishing and wrapping of bulk articles is simple in its constructiveness, and therefore quite viable, obtaining excellent practical and functional results, incorporating an innovative and effective technique.

The twistable polymer film produced with durable and robust raw materials for the purpose proposed, offers the user aesthetic and functional quality, offering a wide range of applications and service practicality.

In order to better understand and comprehend the production process for twistable polymer film or similar product for packaging and other applications claimed herein, all of its descriptions are presented below:

The object of the present patent idealizes a process for the preparation of a polyethylene film with torsion properties, which is obtained through the combination of resins and additives introduced into the extrusion process of the film, blow or cast type, varying between single-extrusion or co-extrusion, where the extruded film can be pigmented with any color, white, blue, among others, through the addition of colored pigments in the production process, or become transparent when no pigment is introduced.

The transparent or colored extruded film can present varying or specific writing styles or colorations relative to the intended motifs or ornamentations with the objective of interacting, informing and even instructing the user through the printing process or sharing with the use of adhesives in a two-film laminating machine, obtaining a film denominated as laminate.

From the possible variations, the following films are obtained:

1—Transparent polyethylene film.

2—Transparent polyethylene film printed with or without varnishes.

3—Pigmented polyethylene film.

4—Pigmented polyethylene film printed with or without varnishes.

5—Transparent polyethylene film coupled/laminated with printed transparent polyethylene film.

6—Transparent polyethylene film coupled/laminated with printed pigmented polyethylene film.

The possible applications of the polymer film can be obtained from the combinations practiced and used for packaging of several products.

Once the user has opened the packaging produced with the twistable polymer film, he could close it again, just by twisting axially, through manual action on its sectioned part, which does not return afterwards to its initial position, before plastic deformation.

The twistable polymer film for packaging provide protection from bad weathers, aesthetic, ornamental, marking or interactive presentation, with flexible thread-like lamellar structure produced from an extruded and synthetic base, acquiring torsion property once resins and additives have been added to the extrusion process.

### Percentile Description of the Chemical Quantities;

The extrusion process in a 3-layer Blow co-extruding machine is defined below, varying the amount of additive in the formulation.

In single-extruding machines, like in co-extruding machines, the composition of the formulation and additives will be thus defined—material in function of the quantity:

| | |
|---|---|
| Polyethylene (PE) | from zero (0%) to thirty (30%) percent. |
| Torsion Additive | from zero (1%) to one hundred (100%) percent. |
| Sliding Additive | from zero (0%) to five (5%) percent. |
| Anti-blocking Additive | from zero (0%) to five (5%) percent. |
| Antistatic Additives | from zero (0%) to five (5%) percent. |
| Color Additives- | from zero (0%) to thirty (30%) percent. |
| pigments | |

Temperatures and other adjustments of the process and machine parameters are adjusted in accordance with the balance of the film components and thickness.

The thickness of the film can vary from fifteen (15) to one hundred (100) microns, in accordance with the application.

The twistable polymer laminate can be sectioned, through different industrial processes, as well as, sewn, pasted or applied in packaging for different purposes.

Thus, it can be verified through the present, that the process claimed herein is characterized by the obtainment of a polymer laminate with torsion attributes for application in the packaging of generic products, as successfully attested from the performed analyses, and through the figures shown, presenting innumerous differences over conventional models present in the consumer market, in addition to constructive and functional technical characteristics completely different from those relating to the state of the art.

Through the advantages that it offers, and also by being covered with truly innovating features that fulfill all peculiar novelty and originality requirements, the present invention meets the necessary conditions to merit invention Privilege.

The present invention concludes that through the employed process, a polyethylene film is obtained with well-defined torsion properties.

In the process of the present invention, the applied temperature range and other process parameters are adjusted in accordance with the balance of the film components and thickness as well as the machines used to develop the process.

For illustration purposes, the temperature ranges applied in the extruding machine zones, divided into zone 1 through zone 5, in order to obtain the desired torsion, are listed below in the following table:

| | TEMPERATURE RANGED | IDEAL TEMPERATURE |
|---|---|---|
| ZONES | USED (° C.) | RANGE (° C.) |
| Z1 | 170-220 | 185 |
| Z2 | 175-225 | 190 |
| Z3 | 185-230 | 195 |
| Z4 | 185-230 | 195 |
| Z5 | 185-230 | 195 |

Film thickness can vary from fifteen (15) to one hundred (100) microns, in accordance with the application, preferably 25 microns.

In the extrusion process using single-extruding machines or co-extruding machine such as the 3-layer Blow, the composition and the amount of additive in the formulation can vary, which can be defined in the following manner:

Polyethylene (PE)—ranging from 0 to 100%, preferably 14%.
The applied PE's in the present invention are those that present low density, high density, medium density or linear. Examples of applied PE, but not exhaustively, are listed below:

Butene-based low density PE

Hexene-based low density PE

Octene-based low density PE

Metallocenic low density PE.

Plastomers or process aids, which can be low density PE with fluor elastomers plus thermal stabilizers ranging from 0 to 1%, preferably 0.5%.
Torsion additives (CCO) with commercial name TOPAZ of the 8007×16 family,—ranging from 10% to 100%, preferably 30%.
Sliding Additive—Amide-based low density (polyamides, eurocamides, oleamides, stearamides and silicones) PE ranging from 0 to 5%, preferably 3%.
Anti-blocking Additive—Silica-based (synthetic or mineral) low density PE ranging from 0 to 5%, preferably 1%.
Antistatic Additives—Low density PE with quaternary amine or ammonium-based cationic compound ranging from 0 to 3%, preferably 1%.
Color Additives—pigments—ranging from 0 to 30%, preferably 4%. PE with pigments used until the amount necessary for obtaining the plastic.

The inflation ratio of the blow-extruding machine is in the ratio of 1:2 and 1:5, preferably 1:3.0.

In the extrusion process the composition of materials is applied, for example, for extrusion of the transparent film in 3-layer extruding machine.

It is important to point out that when one work with one-layer extruding machine, one can use one of the layer compositions of the composition defined in the illustrative examples 4 and 5, or another variation that is created with the intention of adapting the composition to obtain properties that could be lost when leaving co-extrusion to single-extrusion.

Another important aspect to be pointed out in the present invention is that one can also obtain the composition of every transparent or white film, no longer by layer, but by total composition of the transparent film components, the pigmented film, and the final laminated film, i.e. the film resulting from the coupling of the transparent film with the white pigmented film, through the addition of adhesive by lamination process, as illustrated in example 6.

After the extrusion stage of the films, a minimum period of 24 hours is awaited to allow for the migration and equilibrium of all additives and forces of the film in general for subsequent lamination, as illustrated in example 8, and ending with the film finishing process.

After the finishing stage illustrated in example 9, and depending on the type of product to be packed, and the machine that will use the film, there are requirements that must be complied with, such as: Depending on the amount of product to be packed, one must vary the thickness of the films, which will consequently increase the thickness of the final film, so as to support the internal volume of the product. Depending on the quality requirements of the product to be packed, we can vary the balance of the resins such as the sealing resins, such as octene-based Polyethylene, or even change the octene-based polyethylene for a metallocene-based polyethylene in order to improve the resistance of the product to drop tests so as to prevent rupture and leakage.

Another reason for varying the amount of octene or metallocene-based Poly Ethylene is the machine's speed requirement, where one is required to reduce the sealing temperatures of the resins to gain in production of units per minute, reducing sealing temperature, sealing pressure, and the sealing's cooling time.

One of the first characteristics of this film is its hardness, due to the use of Topaz resins in the formulation. The use of Topaz resin reduces the elastic property of the film, consequently increasing its rigidity, or otherwise, reducing the film's memory property. The film's memory property is its ability to return to the initial position after being subjected to a controlled strain. In this case, since the film has its memory property reduced, by applying force on the film, such as a deformation, or twisting, it will present a reduced tendency to return to its initial position, tending to remain in its deformed position. Thus, in practice, we will be able to open such a pack, and to close it again just by twisting it, and it will tend to remain closed.

This property can be balanced in accordance with the application, adding more, or less of the Topaz resin in the formulation, also balancing the other components in order to also attain the drop resistance requirements, sealing improvements, etc.

As a second property to the use of Topaz in the composition of the film, it allow for easier cutting of the film in the machine.

Depending on the application, there is the need to increase torsion properties.

Through the combination of resins and additives introduced in the extrusion process of the film, which can be of the blow type, whose blow-extruding machine's inflation ratio is between 1:2 and 1:5, preferably 1:3.0, or cast, also varying between single-extrusion or co-extrusion, where the stretching ratio ranges between 15× and 50×, preferably 40×, the extruded film can be pigmented in any color, e.g. white or blue, and the pigmentation occurs through the addition of colored pigments in the production process, or transparent when no pigment is introduced.

The transparent or colored extruded film can present varying or specific writing styles and colorations relative to the intended motifs or ornamentations, with the objective of interacting, informing and even instructing the user through the printing process, or sharing with the use of adhesives in a two-film laminating machine, obtaining a film denominated as laminate.

From the possible variations, the following films are obtained:

1—Transparent polyethylene film.

2—Transparent polyethylene film printed with or without varnish.

3—Pigmented polyethylene film.

4—Pigmented polyethylene film printed with or without varnish.

5—Transparent polyethylene film coupled/laminated with printed transparent polyethylene film.

6—Transparent polyethylene film coupled/laminated with printed pigmented polyethylene film.

The possible applications of the polymer film can be obtained from the combinations practiced and used for packaging of different products.

The twistable polymer laminate can be sectioned, through different industrial processes, as well as, sewn, pasted or applied in packaging for various purposes.

After the user has opened the packaging produced with twistable polymer film, he can close it again, by just manually twisting its sectioned part axially, which does not subsequently return to its initial position before plastic deformation.

The twistable polymer film for packaging, provides protection from harsh weather, aesthetic, ornamental, marking or interactive presentations, with flexible thread-like lamellar structure produced from an extruded and synthetic base, acquiring torsion property after resins and additives are added to the extrusion process.

Thus, the present invention was previewed with the objective of obtaining a product for the packaging of hygiene and cleaning articles, among other applications, with fewer possible production processes, conveniently developed and created to allows users to have their products protected against humidity with performance, efficiency and quality, demonstrating unequalled practicality and versatility, incorporating peculiar performances, such as the torsion capacity pertinent to the state of the art.

It is to be understood that the product developed for protection, finishing and wrapping of bulk articles, is simple in its constructiveness, and therefore of easy feasibility, obtaining excellent practical and functional results, incorporating an innovative and effective technique.

As a twistable polymer film produced with durable and robust raw materials for the purposes it is proposed for, it offers the user aesthetic and functional quality, providing a wide range of applications and service practicality.

### EXAMPLE 1

### Process for the Obtainment of a Laminated Film for Use in the Manufacturing of 1—KG Powdered Soap Packaging

The laminated film obtained is formed by a 25-micron sheet of transparent twistable film, and a 25-micron sheet of white twistable film.

### Composition of the Transparent 3-Layer Co-Extruded Film:

a—An external layer of 6.25-micron thickness, composed of 20% low density PE, 15% topaz, 60% octene-based linear PE, 3% sliding agent, 2% anti-blocking agent (layer 1) placed in contact with the sealing bars.
b—An internal layer of 12.5 micron thickness, composed of 20% low density PE, 48% topaz, 3% sliding agent, 29% octene-based linear PE (layer 2).
c—An internal layer of 6.25 micron thickness, composed of 20% low density PE, 15% topaz, 3% sliding agent, 60% octene-based linear PE, 2% anti-blocking agent (layer 3) that will be receiving the corona surface treatment, and in order to receive the adhesive or the printing.
Average temperature range applied: 195° C.

When we talk about co-extrusion, we use the standard temperatures, although adjustments do not always occur, where these temperatures can vary by ±10 C.

Due to the characteristics of the resins and of the extrusion process, the layers are naturally interconnected since the resins of each layer are compatible, presenting affinity, and the combination of the layers occur within the hot machine, at the same temperature of the machine, still in molten state. When the material leaves the machine, the layers cool down together, allowing for their complete fusion, making it practically impossible to separate them, allowing the co-extruded twistable polymer film to be produced in extruding machines of 2 or more layers, preferably of 3, in such manner that it is only necessary to adapt it to the composition and distribution of the layers in accordance with the number of layers and the application. The visualization of the layers is possible only under a high-definition electronic microscope and/or infrared analysis.

### Composition of 3-Layer Co-Extruded White Film:

a—An internal layer of 6.25 micron thickness, composed of 20% low density PE, 17% topaz, 59% octene-based linear PE, 4% sliding agent (layer 1) that will be receiving the surface corona treatment to allow it to receive the adhesive or printing.
b—An internal layer of 12.5-micron thickness, composed of 20% low density PE, 45% topaz, 5% sliding agent, 14% octene-based linear PE and 16% white master batch (layer 2).
c—An external layer of 6.25 micron thickness, composed of 10% low density PE, 50% high density PE, 33% octene-based PE, 4% sliding agent, 2% anti-blocking agent, 1% antistatic agent (layer) placed in contact with the sealing bars.

Average temperature range applied: 195° C.

When we talk about co-extrusion, we use the same standard temperatures, although adjustments do not always occur, where these temperatures can vary by ±10 C. Due to the characteristics of the resins and the extrusion process, the layers are naturally interconnected since the resins of each layer are compatible, presenting affinity and the combination of the layers occur within the hot machine, at the same temperature as the machine, still in the molten state.

When the material leaves the machine, the layers cool down together allowing for the complete fusion to occur, making it practically impossible to separate them, allowing the co-extruded twistable polymer film to be produced in extruding machines of 2 or more layers, preferably 3, in such manner that it only requires adapting it to the composition and distribution of the layers in accordance with the number of layers and the application. The visualization of the layers is possible only under a electronic, high-definition microscope, and/or Infrared analysis.

### EXAMPLE 2

### Final Composition for the 25-Micron Transparent Film

Low density PE . . . 20%

### Topaz . . . 31.5%

Sliding agent . . . 3%.
Anti-blocking agent . . . 1%
Octene-based low density PE . . . 44.5%

### EXAMPLE 3

### Final composition for the 25-Micron white film

Low density PE . . . 7.5%

### Topaz . . . 26.75%

Sliding agent . . . 4.5%
Anti-blocking agent . . . 0.5%
Octene-based low density PE . . . 44.5%
High density PE . . . 22.5%
White Master batch . . . 8%
Antistatic agent . . . 0.25%

### EXAMPLE 4

### Composition of Materials for Extrusion of 25-Micron Transparent Film in 3-Layer Co-Extruding Machine

External sealing side: total 25%—Layer 1

### 0% LLD-PE

### 20% LD-PE

### 0% HD-PE

0% mLLD-PE

### 15% Topaz 8007×16

### 3% Slip MB

2% anti-blocking agent MB

### 60% Octene-based LLD-PE

thickness 6.25
Internal sealing side: total 50%—Layer 2

### 0% LLD-PE

### 20% LD-PE

### 0% HD-PE

0% mLLD-PE

### 48% Topaz 8007×16

### 3% Slip MB

0% anti-blocking agent MB

### 29% Octene-based LLD-PE

Corona-treated external side to receive adhesive or printing: total 25%—Layer 3

### 0% LLD-PE

### 20% LD-PE

### 0% HD-PE

0% mLLD-PE

### 15% Topaz 8007×16

### 3% Slip MB

2% anti-blocking agent MB

### 60% Octene-based LLD-PE

### EXAMPLE 5

### Composition of materials for extrusion of 25-micron white film in 3-layer co-extruding machine

External sealing side: total 25%—Layer 1

### 0% LLD-PE

### 20% LD-PE

### 0% HD-PE

0% mLLD-PE

### 17% Topaz 8007×16

4% sliding agent MB

### 59% Octene-based LLD-PE

thickness 6.25
Internal sealing side: total 50%—Layer 2

### 0% LLD-PE

### 0% LD-PE

### 20% HD-PE

0% mLLD-PE

### 48% Topaz 8007×16

### 16% White MB

5% sliding agent MB

### 14% Octene-based LLD-PE

thickness 12.5
Corona-treated external side to receive adhesive or printing: total 25%—Layer 3

### 0% LLD-PE

### 10% LD-PE

### 50% HD-PE

0% mLLD-PE

### 0% Topaz8007×16

4% sliding agent MB
2% anti-blocking agent MB
15% antistatic agent MB

### 33% Octene-based LLD-PE

thickness 6.25

### EXAMPLE 6

### Total Composition of the Components of the Transparent Film, the Pigmented Film, and the Final Laminated Film Resulting from the Coupling of the Transparent Film with the White Pigmented Film, through the Addition of Adhesive by Lamination Process

### Transparent Film:

### 0% LD-PE

### 20% LLD-PE

### 0% HD-PE

### 0% Metallocene PE

### 31.5% Topaz 8007 (CCO)

### 0% White Pigment

### 3% Sliding Agent

### 1% Anti-Blocking Agent

### 0% Antistatic Agent

44.5% octene-based LLD-PE

### White Film:

### 0% LD-PE

### 7.5% LLD-PE

### 22.5% HD-PE

### 0% Metallocene PE

### 26.5% Topaz 8007 (CCO)

### 8% White Pigment

### 4.5% Sliding Agent

### 0.5% Anti-Blocking Agent

### 0.25% Antistatic Agent

30% octene-based LLD-PE

### Laminated Film:

### 0% LD-PE

### 13.75% LLD-PE

### 11.25% HD-PE

### 0% Metallocene PE

### 29.13% Topaz 8007 (CCO)

### 4% White Pigment

### 3.75% Sliding Agent

### 0.75% Anti-Blocking Agent

### 0.13% Antistatic Agent

37.25% octene-based LLD-PE

### EXAMPLE 7

### Printing Process

This process consists of printing an artwork, with lay-out over the pigmented film, through a flexographic or rotographic printer, The Film, now printed, should be cured for a period of 12 hours to allow the catalyst reactions of the dyes, and the drying and elimination of the residual solvents contained in the dye before moving on to the next lamination process, where the two films will be coupled in the laminating machine to form a single film.

### EXAMPLE 8

### The Lamination Process

The lamination process consists of continuously applying an adhesive on the surface of a film such as, for example, the Adhesive manufactured by Henkel do Brasil, whose adhesive code is LIOFOL 9526 and the Catalyst is 9727, which is considered an aromatic type adhesive, without solvent, polyurethane-based, among the ones available in the market. There are also cases where we use Aliphatic type adhesives like that of Henkel, where the Adhesive is LIOFOL UR 7390 and the catalyst, UR 8192, whose adhesive weight applied varies from 1.4 g/m² up to 2.6 g/m², preferably 2.0 g/m², in accordance with the need of the packaging application. With respect to the application time, we can affirm that the adhesive is applied in the machine at the speed of 100 to 300 m/sec on the treated side, which afterwards comes in contact with the other film, which can be a film of the previously mentioned examples, or other materials, such as: Paper, aluminum sheets, HD-PE film, or, either torsion OBPP or torsion PP film, on the treated side where an adhesion occurs between the films, on the treated side, which later comes in contact with the other film, on the treated side where an adhesion occurs between the films, allowing for the obtainment of a single film, now denominated as laminate, and that is kept resting for at least 36 hours, so that the crystallization reactions of the adhesive with the catalyst may occur, characterizing the adhesion of the two films into a one.

### EXAMPLE 9

### The Film Finishing Process

After the recovery period of the material, preferably 36 hours, the film is placed in a re-spooling machine that will cut the film with the correct width, in accordance with the format of FFS (Form Fill and Seal) shaping tube of the packaging machine. The spools are then cut, refilled, packed and stowed for transport to the companies that will package the products.

1-57. (canceled)

58. A method of manufacturing a twistable polymer film comprising:
operating a single-extruding or co-extruding machine to make an extrusion wherein a composition and quantity of additive is utilized and wherein a stretching ratio ranges between 15× and 50×;
operating a cast extruding machine or blow extruding machine to make an extrusion wherein an inflation ratio of said blow extruding machine is between 1:2 and 1:5;
applying temperature ranges in the extruding machine zones of Z1 from 170 to 220° C., Z2 from 175 to 225° C., Z3 from 185 to 230° C., Z4 from 185 to 230° C. and Z5 from 185 to 230° C.

59. The method of claim 58 comprising:
utilizing said composition and quantity of additive in said co-extruding machine from 0 to 30% of polyethylene (PE), from 1% to 100% of torsion additives (COC), from 0 to 5% of sliding additive, from 0 to 5% of antiblocking additive, from 0 to 5% of antistatic additive and from 0 to 30% of color additive and wherein said polyethylene (PE) applied presents low density, high density, medium density or linear.

60. The method of claim 58 comprising:
utilizing said composition and quantity of additive from 0 to 100% of polyethylene (PE), from 0 to 1% of plastomers or process aids, from 10% to 100% of torsion additives (COC), from 0 to 5% of sliding additive, from 0 to 5% of antiblocking additive, from 0 to 3% of antistatic additive and from 0 to 30% of color additive and wherein said polyethylene (PE) applied presents low density, high density, medium density or linear.

61. The method of claim 58 comprising:
utilizing polyethylene (PE) selected from the group consisting of Butene-based low density PE, Hexene-based low density PE, Octene-based low density PE and Metallocenic low density PE.

62. The method of claim 58 comprising:
applying a plastomer or process aid of low density PE comprising a fluor elastomer and thermal stabilizer.

63. The method of claim 58 comprising:
applying a sliding additive comprising an amide-based low density PE.

64. The method of claim 58 comprising:
applying an anti-blocking additive comprising a silica-based low density PE.

65. The method of claim 58 comprising:
applying an antistatic additive comprising a low density PE with a quaternary amine or ammonium-based cationic compound.

66. The method of claim 58 comprising:
coloring said extrusion through addition of a colored pigment.

67. The method of claim 58 comprising:
utilizing an external sealing side layer composition comprising 25% of said extrusion wherein said external sealing side comprises:
20% LD-PE,
15% cyclic copolymer,
3% Slip,
2% anti-blocking agent,
60% octene-based LLD-PE thickness 6.25;
utilizing an internal sealing side layer composition comprising 50% of said extrusion wherein said external sealing side comprises:
20% LD-PE,
48% cyclic copolymer,
3% Slip,
29% octene-based LLD-PE; and,
utilizing a corona-treated external side layer composition to receive adhesive or printing comprising 25% of said extrusion wherein said external sealing side comprises:
20% LD-PE,
15% cyclic copolymer,
3% Slip,
2% anti-blocking agent,
60% octene-based LLD-PE.

68. The method of claim 58 comprising:
utilizing an external sealing side layer composition comprising 25% of said extrusion wherein said external sealing side comprises:
20% LD-PE,
17% cyclic copolymer,
4% sliding agent,
59% octene-based LLD-PE thickness 6.25;
utilizing an internal sealing side layer composition comprising 50% of said extrusion wherein said external sealing side comprises:
20% HD-PE,
45% cyclic copolymer,
16% white,
5% sliding agent,
14% octene-based LLD-PE; and,
utilizing a corona-treated external side layer composition to receive adhesive or printing comprising 25% of said extrusion wherein said external sealing side comprises:
10% LD-PE,
50% HD-PE,
4% sliding agent,
2% anti-blocking agent,
1% antistatic agent,
33% octene-based LLD-PE.

69. The method of claim 58 comprising:
coupling a transparent layer with a pigmented layer through use of an adhesive.

70. The method of claim 58 comprising:
utilizing a composition for a transparent film comprising:
20% LLD-PE,
31.5% cyclic copolymer,
3% sliding agent,
1% anti-blocking agent,
44.5% octene-based LLD-PE.

71. The method of claim 58 comprising:
utilizing a composition for a white film comprising:
7.5% LLD-PE,
22.5% HD-PE,
26.75% cyclic copolymer,
8% white pigment,
4.5% sliding agent,
0.5% anti-blocking agent,
0.25% antistatic agent,
30% octene-based LLD-PE.

72. The method of claim 58 comprising:
utilizing a composition for a laminated film comprising:
13.75% LLD-PE,
11.25% HD-PE,
29.12% cyclic copolymer,
4% white pigment,
3.75% sliding agent,
0.75% anti-blocking agent,
0.13% antistatic agent,
37.25% octene-based LLD-PE.

73. The method of claim 58 comprising:
printing over a film using a flexographic or rotographic printer.

74. The method of claim 73 comprising:
curing said film after said film is printed to allow for the elimination in solvents in dye.

75. The method of claim 58 comprising:
applying an aromatic type adhesive without solvent.

76. The method of claim 58 comprising:
applying an aliphatic type adhesive, whose adhesive weight varies from 1.4 g/m2 to 2.6 g/m2.

77. The method of claim 58 comprising:
adhering paper sheets, aluminum sheets, HE-PE film, torsion OBPP or torsion PP film to said extrusion.

78. The method of claim 58 comprising:
obtaining a film between 15 and 100 microns in thickness.

79. The method of claim 58 comprising:
utilizing a composition for an external layer comprising:
20% LD-PE,
15% cyclic copolymer,
60% octene-based LLD-PE,
3% sliding agent,
2% anti-blocking agent;
utilizing a composition for an internal layer comprising:
20% LD-PE,
48% cyclic copolymer,
3% sliding agent,
29% octene-based LLD-PE; and,
utilizing a composition for a second internal layer comprising:
20% LD-PE,
15% cyclic copolymer,
3% sliding agent,
60% octene-based LLD-PE,
2% anti-blocking agent.

80. The method of claim 58 comprising:
utilizing a composition for an external layer comprising:
20% LD-PE,
17% cyclic copolymer,
59% octene-based LLD-PE,
4% sliding agent;
utilizing a composition for an internal layer comprising:
20% LD-PE,
48% cyclic copolymer,
5% sliding agent,
7 of 9
16% white,
14% octene-based LLD-PE; and,
utilizing a composition for a second external layer to receive adhesive or printing comprising:
10% LD-PE,
50% HD-PE,
4% sliding agent,
1% antistatic agent,
33% octene-based LLD-PE,
2% anti-blocking agent.

81. The method of claim 58 comprising:
introducing hardness into said extrusion through use of a cyclic copolymer.

82. The method of claim 58 comprising:
reducing elasticity in said extrusion through use of a cyclic copolymer.

83. The method of claim 58 comprising:
producing said extrusion wherein said extrusion is configured to be used for packaging and wherein said packaging may be closed after use by twisting a portion of said packaging axially and wherein said portion does not subsequently return to an initial open position.

84. The method of claim 58 comprising:
producing said extrusion wherein said extrusion is configured to be used for vertical form fill and seal packaging.

85. The method of claim 58 comprising:
producing said extrusion wherein said extrusion is configured to be used for food, animal food, hygiene, cleaning or soap packaging.
